(19) United States
(12) Patent Application Publication
(10) Pub. No.: US 2024/0430282 A1
(43) Pub. Date: Dec. 26, 2024

(54) GENERALIZED BEHAVIOR ANALYTICS FRAMEWORK FOR DETECTING AND PREVENTING DIFFERENT TYPES OF API SECURITY VULNERABILITIES

(71) Applicant: Traceable Inc, San Francisco, CA (US)

(72) Inventors: Jisheng Wang, Palo Alto, CA (US); Sanjay Nagaraj, Dublin, CA (US)

(21) Appl. No.: 18/419,593

(22) Filed: Jan. 23, 2024

Related U.S. Application Data
(60) Provisional application No. 63/510,151, filed on Jun. 26, 2023.

(51) Int. Cl. H04L 9/40

(52) U.S. Cl. CPC H04L 63/1425; H04L 63/1433

(57) ABSTRACT

A behavior analytics method for detecting and preventing different types of API based threats and attacks is disclosed. The method includes collecting request and response data of API calls from plurality of user sessions and storing it in a data lake. The method further includes extracting and combining features of the collected request and response data. The features may be associated with login behavior, API request content and behavior, API object accessing content and behavior, and API response content and behavior. The method also includes encoding the combined features via a neural network model to create a behavior fingerprint of each of the user sessions. Also, the method includes clustering the created behavior fingerprint to detect normal or abnormal user behavior. Thereafter, the method includes reporting the detected abnormal user behavior.

### CROSS REFERENCE TO RELATED APPLICATION

The present application claims the priority benefit of U.S. provisional patent application 63/510,151, filed on 26 Jun. 2023, titled “GENERALIZED BEHAVIOR ANALYTICS FRAMEWORK FOR DETECTING AND PREVENTING DIFFERENT TYPES OF API SECURITY VULNERABILITIES”, which is fully and completely incorporated by reference herein.

### BACKGROUND

### Technical Field

The present disclosure relates to the field of Application Programming Interface (API) security, and particularly relates to a generalized behavior analytics framework for detecting and preventing different types of API security vulnerabilities.

### Description of the Related Art

Application Programming Interface (API) security vulnerabilities occur if the APIs are not properly secured from unauthorized access, data breaches, and/or other malicious activities. API calls made during authentication and authorization, access control, encryption, input validation, and sanitization, rate limiting and throttling, error handling, monitoring and logging, and regular security audits and testing might be vulnerable to security risk. Thus, API security is a crucial aspect of overall enterprise or application security, as compromised or poorly secured APIs can expose sensitive data, enable unauthorized access, and compromise the integrity of enterprise or application security. It has been observed that security attacks can be conducted over a period of time (e.g., over days, weeks, or months) with multiple actors evolving over different attack phases of an attack chain. Different phases of the attack chain can include reconnaissance, resource development, initial access, execution, persistence, privilege escalation, defense evasion, credential access, lateral movement, command and control, and exfiltration. The conventional solutions for API security disclose detecting anomalies during specific phases and specific types of API security vulnerabilities but they do not detect anomalies in the entirety of the attack chain (i.e., during all the phases). For example, a conventional technology associated with detecting API security vulnerabilities based on log-in will not be able to detect API security vulnerabilities associated with exfiltration if an attacker successfully passes the authentication process. As a result, the conventional technologies fail to determine and/or analyze the complete picture of how a sophisticated API attack has been conducted and/or evolved step-by-step targeting.

Therefore, there is a need for a solution for generalized behavior analytics to detect and prevent different types of API security vulnerabilities across different phases of the attack chain and improve the API security of a protected environment.

### BRIEF SUMMARY

One or more embodiments are directed to a behavior analytics system and method for detecting and preventing different types of Application Programming Interface (API) vulnerabilities and attacks.

An embodiment of the present disclosure discloses a behavior analytics system that includes a collection engine to collect request and response data of one or more API calls, associated to an application in a protected environment, made during one or more user sessions. Such request and response may correspond to one or more API calls including initial authentication, authorization, and/or one or more Hyper Text Transfer Protocol (HTTP) requests and responses made afterward. The collection engine collects complete header information, cookies, and the body of each request and response of one or more API calls. The collection engine may store the collected request and response data of the API calls in a data lake for detailed analysis at any point in time. The request and response data may include data related to an API source, API endpoint, the parameters sent in an API request, the cookie used in the request, the detailed information sent in the request body (e.g., user id, token id, etc), the status code of the API response, the parameters received from response header, all detailed content received from the response body including business-specific content, PII, and an object used.

In an embodiment, the behavior analytics system includes an API sequence engine to combine one or more features extracted from the collected request and response data of API calls over multiple consecutive API requests and responses from a certain user session, and encode them via a neural-network-based embedding technology to create a behavior fingerprint of each user session.

In an embodiment, the behavior analytics system includes a clustering engine that receives the behavior fingerprint of each user session and clusters them to identify normal user behavior or abnormal user behavior.

The one or more features used by the API sequence engine may be associated with login behavior, API request content and behavior, API object accessing content and behavior, and API response content and behavior. The login behavior is analyzed to determine from where the API calls are coming. Data or features associated to login behavior include Internet Protocol (IP) addresses, geolocations, and/or Autonomous System Numbers (ASNs) of devices from which API calls may have originated or routed through. The API request content and behavior are analyzed to determine what these API calls intend to do. Data or features associated with API request content and behavior include API endpoints and/or a time-series pattern of API calls made by a user or service during a particular login session. The API object accessing content and behavior is analyzed to determine the target resource, service, or data. Data or features associated with API object accessing content and behavior include all object types and object values accessed during a particular login session. The API response content and behavior are analyzed to determine what the user or services making these API calls are getting. Data or features associated with API response content and behavior may include a response status code and/or a body content that the user or the service receives during a particular login session. The API sequence engine encodes the combined one or more features via a neural network-based embedding model to create a behavior fingerprint of each of the one or more user sessions.

In an embodiment, the behavior analytics system includes a report and response engine to report the detected abnormal user behavior. Upon detection, the report and response engine sends the detected abnormal user behavior to a system administrator who can take corrective action. The system administrator can validate that the identified abnormal behavior is indeed an abnormal behavior. The report and response engine may take the necessary action automatically to mitigate the effects of the abnormal user behavior if the magnitude of the associated threat is more than the pre-defined threshold. The report and response engine of the behavior analytics system may present a complete picture of how an API attack was conducted and evolved step by step to target resources or services of the protected environment. The temporal correlation across the attack chain over time is helpful for early vulnerability detection and forensic analysis.

The proposed system provides a generalized behavior analytics framework for detecting API security threats and attacks. As against the traditional system, the proposed system provides coverage for all types of attacks across different phases of a complete attack chain. The behavior analytics system correlates different attack use uses, and detections across different attack stages to detect even the most sophisticated coordinated attacks carried out over a period of time. The proposed system may use specialized abnormality detection models designed for specific attack stages or use cases to detect security vulnerabilities specific to that attack stage or use case, and correlate the detected vulnerability across different attack stages or use cases to create the behavior fingerprint of the user or the service. The use cases covered by the behavior analytics system include fake account creation, credential stuffing, token manipulation, Broken Object Level Authorization (BOLA)/Broken Function Level Authorization (BFLA), account takeover, referral fraud, and data exfiltration. The specialized abnormality detection models may include a time series anomaly detection model, a peer group anomaly detection model, a high dimensional graph clustering model, a sequence representation & embedding model, a Natural Language Processing (NLP) tokenization and encoding model, and a graph neural network model.

In an embodiment, the behavior analytics system may use individual behavior anomaly detection models to detect specific types of attacks, such as login behavior anomaly, for fake account creation detection, object anomaly detection for BOLA and BLFA detection, etc., in the first phase and correlate different anomaly events (e.g. following MITRE attack framework) from one or multiple users or services to detect even larger organized attacks or incidents, in the second phase.

Different specialized anomaly detection models, designed to detect anomalies at different stages or covering different use cases, may extract a different set of features from the collected request and response data from the data lake. For example, an API sequence-based anomaly detection model may extract features from request and response data of API calls made after login, as it focuses on the user behavior after login.

An embodiment of the present disclosure discloses a behavior analytics method for detecting and preventing different types of Application Programming Interface (API) vulnerabilities and attacks. The behavior analytics method includes the steps of collecting requests and responses data of one or more API calls, associated to a protected environment, made during one or more user sessions. The method may also include the steps of storing the collected requests and responses in a data lake for detailed analysis at any point of time. Further, the method includes the steps of combining one or more features extracted from the collected requests and responses data of API calls over multiple consecutive API requests and responses from a certain user session, and encoding them via a neural-network-based embedding technology to create a behavior fingerprint of each user session. Also, the method includes the steps of receiving the behavior fingerprint of each user session and clustering them to identify normal user behavior or an abnormal user behavior. Thereafter, the method includes the steps of reporting the detected abnormal user behavior. Additionally, the method includes the steps of sending, upon detection, the detected abnormal user behavior to a system administrator who can take corrective action. The system administrator can validate that the identified abnormal behavior is indeed an abnormal behavior. Further, the method includes the steps of taking the necessary action to mitigate the effects of the abnormal user behavior if magnitude of associated threat is more than the pre-defined threshold.

The features and advantages of the subject matter here will become more apparent in light of the following detailed description of selected embodiments, as illustrated in the accompanying FIGUREs. As will be realized, the subject matter disclosed is capable of modifications in various respects, all without departing from the scope of the subject matter. Accordingly, the drawings and the description are to be regarded as illustrative in nature.

### BRIEF DESCRIPTION OF THE DRAWINGS

In the figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 illustrates an exemplary environment of a behavior analytics system for detecting and preventing different types of Application Programming Interface (API) based threats and attacks, in accordance with an embodiment of the present disclosure.

FIG. 2 illustrates a detailed block diagram showing functional modules of the behavior analytics system for detecting and preventing different types of API-based threats and attacks, in accordance with an embodiment of the present disclosure.

FIG. 3 shows exemplary data that is stored in an API data lake, in accordance with an embodiment of the present disclosure.

FIG. 4 shows exemplary uses of the API data lake that provides 360-degree contextual data of each API, in accordance with an embodiment of the present disclosure.

FIG. 5A shows exemplary clusters created by the clustering engine to detect normal and abnormal user behavior indicating fake accounts that can be detected by the behavior analytics system, in accordance with an embodiment of the present disclosure.

FIG. 5B shows an exemplary cluster indicating fake accounts using the behavior analytics system, in accordance with an embodiment of the present disclosure.

FIG. 6 shows exemplary outliers in the clusters indicating potential fraud that can be detected by the behavior analytics system, in accordance with an embodiment of the present disclosure.

FIG. 7 shows yet another exemplary cluster indicating a data exfiltration attack that can be detected by the behavior analytics system, in accordance with an embodiment of the present disclosure.

FIG. 8 shows a block diagram illustrating comprehensive data collection, threat detection, and reporting offered for API protection by the behavior analytics system, in accordance with an embodiment of the present disclosure.

FIG. 9 is a flow chart of a behavior analytics method for detecting and preventing different types of API based threats and attacks based on behavior analytics, in accordance with an embodiment of the present disclosure.

FIG. 10 illustrates an exemplary computer unit in which or with which embodiments of the present disclosure may be utilized.

Other features of embodiments of the present disclosure will be apparent from accompanying drawings and detailed description that follows.

### DETAILED DESCRIPTION

Embodiments of the present disclosure include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, firmware, and/or by human operators.

Embodiments of the present disclosure may be provided as a computer program product, which may include a machine-readable storage medium tangibly embodying thereon instructions, which may be used to program the computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), crasable PROMs (EPROMs), electrically crasable PROMs (EEPROMs), flash memory, magnetic or optical cards, or other types of media/machine-readable medium suitable for storing electronic instructions (e.g., computer programming code, such as software or firmware).

Various methods described herein may be practiced by combining one or more machine-readable storage media containing the code according to the present disclosure with appropriate standard computer hardware to execute the code contained therein. An apparatus for practicing various embodiments of the present disclosure may involve one or more computers (or one or more processors within the single computer) and storage systems containing or having network access to a computer program(s) coded in accordance with various methods described herein, and the method steps of the disclosure could be accomplished by modules, routines, subroutines, or subparts of a computer program product.

### Terminology

Brief definitions of terms used throughout this application are given below.

The terms “connected” or “coupled”, and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context dictates otherwise. Also, as used in the description herein, the meaning of “in” includes “in” and “on” unless the context dictates otherwise.

The phrases “in an embodiment,” “according to one embodiment,” and the like generally mean the particular feature, structure, or characteristic following the phrase is included in at least one embodiment of the present disclosure and may be included in more than one embodiment of the present disclosure. Importantly, such phrases do not necessarily refer to the same embodiment.

Exemplary embodiments will now be described more fully hereinafter with reference to the accompanying drawings, in which exemplary embodiments are shown. This disclosure may, however, be embodied in many different forms and should not be construed as limited to the embodiments set forth herein. These embodiments are provided so that this disclosure will be thorough and complete and will fully convey the scope of the disclosure to those of ordinary skill in the art. Moreover, all statements herein reciting embodiments of the disclosure, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating systems and methods embodying this disclosure. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this disclosure. Those of ordinary skill in the art further understand that the exemplary hardware, software, processes, methods, and/or operating systems described herein are for illustrative purposes and, thus, are not intended to be limited to any particular named.

Embodiments of the present disclosure relate to a behavior analytics system and method for detecting and preventing different types of Application Programming Interface (API) vulnerabilities and attacks. The behavior analytics system collects request and response data of one or more API calls associated to an application in a protected environment made during one or more user sessions by one or more users or one or more services. The request and response data may include data related to an API source, API endpoint, the parameters sent in an API request, the cookie used in the request, the detailed information sent in the request body (e.g., user id, token id, etc), the status code of the API response, the parameters received from response header, all detailed content received from the response body including business-specific content, PII, and an object used. The behavior analytics system combines one or more features of the collected request and response data of API calls over multiple consecutive API requests and responses from a certain user session and encodes them via a neural-network-based embedding technology to create a behavior fingerprint of each user session. The behavior fingerprint of each user session is fed to a clustering engine that clusters them to identify normal user behavior or abnormal user behavior.

The one or more features used by the behavior analytics system may be associated with login behavior, API request content and behavior, API object accessing content and behavior, and API response content and behavior. Data or features associated to login behavior include Internet Protocol (IP) addresses, geolocations, and/or Autonomous System Numbers (ASNs) of devices from which API calls may have originated or routed through. Data or features associated with API request content and behavior include API endpoints and/or a time-series pattern of API calls made by a user or service during a particular login session. Data or features associated with API object accessing content and behavior include all object types and object values accessed during a particular login session. Data or features associated with API response content and behavior may include a response status code and/or a body content that the user or the service receives during a particular login session. The API sequence engine encodes the combined one or more features via a neural network-based embedding model to create a behavior fingerprint of each of the one or more user sessions.

The proposed system provides a generalized behavior analytics framework for detecting API security threats and attacks. As against the traditional system, the proposed system provides coverage for all types of attacks across different phases of a complete attack chain. The behavior analytics system correlates different attack use uses, and detections across different attack stages to detect even the most sophisticated coordinated attacks carried out over a period of time. The proposed system may use specialized abnormality detection models designed for specific attack stages or use cases to detect security vulnerabilities specific to that attack stage or use case, and correlate the detected vulnerability across different attack stages or use cases to create the behavior fingerprint of the user or the service. The use cases covered by the behavior analytics system includes fake account creation, credential stuffing, token manipulation, Broken Object Level Authorization (BOLA)/Broken Function Level Authorization (BFLA), account takeover, referral fraud, and data exfiltration. The specialized abnormality detection models may include a time series anomaly detection model, a peer group anomaly detection model, a high dimensional graph clustering model, a sequence representation & embedding model, a Natural Language Processing (NLP) tokenization and encoding model, and a graph neural network model.

In an embodiment, the behavior analytics system may use individual behavior anomaly detection models to detect specific types of attacks, such as login behavior anomaly, for fake account creation detection, object anomaly detection for BOLA and BLFA detection, etc., in the first phase and correlate different anomaly events (e.g., following MITRE attack framework) from one or multiple users or services to detect even larger organized attacks or incidents, in the second phase.

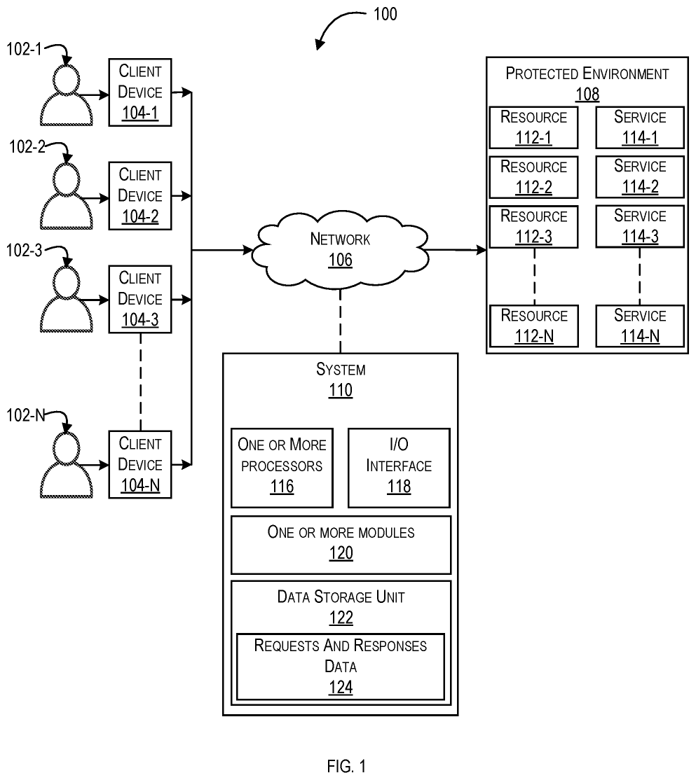

FIG. 1 illustrates an exemplary environment 100 of a behavior analytics system 110 for detecting and preventing different types of Application Programming Interface (API) based threats or attacks, in accordance with an embodiment of the present disclosure. As shown in FIG. 1, the exemplary environment 100 comprises one or more users 102-1, 102-2, 102-3, and 102-N (hereinafter known as user 102), one or more client devices 104-1, 104-2, 104-3, 104-N (hereinafter known as client device 104, or the user device 104), a network 106, a protected environment 108, and the behavior analytics system 110. The exemplary environment 100 may be established to detect and prevent various API based threats or attacks in the protected environment 108 in relation to one or more resources 112-1, 112-2, 112-3, and 112-N (hereinafter known as resources 112) and/or one or more services 114-1, 114-2, 114-3, and 114-N (hereinafter known as services 114). The resources 112 of the protected environment 108 may, without any limitation, include a server, a cloud server, a network, an end-user device, a printer, an access control device, a data storage unit, a processing unit, and other connected devices. The services 114, without any limitation, include any applications or any software services.

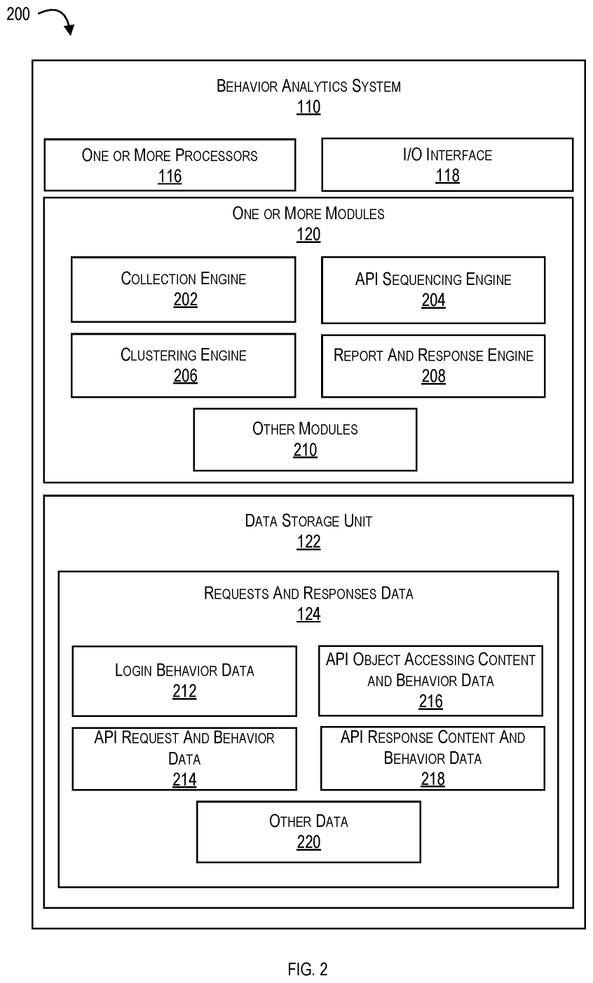

As illustrated, each user 102 may be communicatively coupled to the protected environment 108 through associated client device 104 via the network 106. Any of the user 102 may be a malicious user or any client device 104 may be a device that is used to initiate or route an API attack. The network 106 (such as a communication network) may include, without limitation, a direct interconnection, a Local Area Network (LAN), a Wide Area Network (WAN), a wireless network (e.g., using Wireless Application Protocol), the Internet, and the like. In an alternate embodiment, each client device 104 may be communicatively coupled to the behavior analytics system 110 via a corresponding dedicated communication network (not shown in FIG.). The behavior analytics system 110 may be in the premise of the protected environment 108 or part of the enterprise network of the protected environment 108. In an embodiment, the behavior analysis system 110 may be connected to the protected environment 108 through the network 106. In an embodiment, the behavior analysis system 110 may be configured to provide on-demand service or to work as Software as a Service (SaaS), or Platform as a Service (PaaS). In whichever configuration it is used, the behavior analysis system 110 needs to have visibility and access to all the in-bound and out-bound API calls to and from the protected environment 108. Typically, one or more API calls are generated when different resources 112 or services 114 communicate, either with each other or with one or more components outside the protected environment 108. The behavior analytics system 110 may monitor/fetch/receive such one or more API calls during an entire process of such communications to understand the behavior changes from the normal situations across multiple user sessions. Further, the behavior analytics system 110 analyses such behavior changes to detect if there is an anomaly, indicative of an attack such as hacking, financial fraud, network attack, exfiltration, or the like on the protected environment 108. Upon detecting the anomaly, the behavior analytics system 110 may report such an attack to a system administrator or a user responsible for taking a suitable action. In an embodiment, the behavior analytics system 110 may take a suitable action automatically to mitigate the effects of such anomalies. The behavior analytics system 110 has been discussed in detail in conjunction with FIG. 2 in the following paragraphs.

FIG. 2 illustrates a detailed block diagram 200 showing functional modules of the behavior analytics system 110 for detecting and preventing different types of API-based threats and attacks, in accordance with an embodiment of the present disclosure.

The behavior analytics system 110 may include one or more processors 116, an Input/Output (I/O) interface 118, one or more modules 120 (may also be termed as one or more engines 120), and a data storage unit 122. In some non-limiting embodiments or aspects, the data storage unit 122 may be communicatively coupled to the one or more processors 116. The data storage unit 122 stores instructions, executable by the one or more processors 116, which on execution, may cause the behavior analytics system 110 to detect anomalies in the protected environment 108 and/or mitigate the effects of such detected anomalies. In some non-limiting embodiments or aspects, the data storage unit 122 may store requests and responses data 124. The one or more modules 120 may perform the steps of the present disclosure using the requests and responses data 124 (whether monitored/or received/or fetched) associated with one or more API calls associated with the protected environment 108 to detect anomalies. In some non-limiting embodiments or aspects, each of the one or more modules 120 may be a hardware unit, which may be outside the data storage unit 122 and coupled with the behavior analytics system 110. In some non-limiting embodiments or aspects, the behavior analytics system 110 may be implemented in a variety of computing systems, such as a laptop computer, a desktop computer, a Personal Computer (PC), a notebook, a smartphone, a tablet, e-book readers, a server, a network server, a cloud server, and the like. In a non-limiting embodiment, each of the one or more modules 120 may be implemented with a cloud-based server, communicatively coupled with the behavior analytics system 110.

In one implementation, the one or more modules 120 may include, but is not limited to, a collection engine 202, an API sequencing engine 204, a clustering engine 206, a report and response engine 208, and one or more other modules 210 associated with the behavior analytics system 110. In some non-limiting embodiments or aspects, the request and response data 124 stored in the data storage unit 122 may include data associated with login behavior 212, data associated with API request content and behavior 214, data associated with API object accessing content and behavior 216, data associated with API response content and behavior 218, and other data 220 associated with the behavior analytics system 110. In some non-limiting embodiments or aspects, such data in the data storage unit 122 may be processed by the one or more modules 120 of the behavior analytics system 110. In some non-limiting embodiments or aspects, the one or more modules 120 may be implemented as dedicated units and when implemented in such a manner, the modules may have the functionality defined in the present disclosure to result in novel hardware. As used herein, the term module may refer to an Application Specific Integrated Circuit (ASIC), an electronic circuit, Field-Programmable Gate Arrays (FPGA), a Programmable System-on-Chip (PSoC), a combinational logic circuit, and/or other suitable components that provide the described functionality. The one or more modules 120 of the present disclosure control the access to the virtual and real-world environment, such that the behavior analytics system 110 may be utilized for detecting anomalies in virtual environments (such as virtual-reality, augmented-reality, or metaverse) similar to the real-world environments that has been focused (for the sake of brevity) in the present disclosure. The one or more modules 120 along with its stored data, may be implemented in any processing system or device for detecting anomalies associated with API security. In a non-limiting embodiment, the proposed processing unit may be implemented within a kernel of a computing device for detecting the anomalies associated with the API security. The kernel along with software and hardware modules of said computing device may function and operate to detect anomalies associated with the API security threats, originating from any of the user devices 104, to the protected environment 108 and mitigate the effects of such anomalies.

In some embodiments, the collection engine 202 may collect request and response data of one or more API calls during one or more user sessions. It may be noted that for the sake of the present disclosure, the one or more user sessions correspond to a period of time in which the user accesses the protected environment 108, i.e., period during which users initiate API calls and receive a response to API calls, including API calls made during authentication, authorization and any subsequent request and response to and from any of the resources 112 or services 114. Such one or more API calls may be associated with the protected environment 108, such as based on the communication of the one or more components of the protected environment 108 either with each other or with one or more components out of the protected environment 108. The one or more API calls may have been initiated by one or more users and/or services. Further, the one or more API calls may, without any limitation, include initial authentication, authorization, and one or more Hyper Text Transfer Protocol (HTTP) requests and responses during a user session. In a non-limiting example, the one or more API calls are generated whenever a user logs into a client device, accesses a network, accesses a web address, opens an application, copies a file, pastes a file, opens settings, makes an internal function call, make external function calls, or perform any other operation in the protected environment 108. In another non-limiting example, the one or more API calls are generated when a service performs an action, such as accessing a database, connecting to a network, opening a webpage, connecting to a server, transferring data to the server, downloading data from the server, or the like.

In some embodiments, the collection engine 202 stores the collected request and response data 124 in the data storage unit 122 for detailed analysis at any point of time. This storing of the response and request data facilitates the behavior analytics system 110 to understand a behavioral change (of a user, or a client device, or an application, or a service, or a network) that occurs over time (e.g., over days, weeks, or months) and may be utilized to determine and analyze a complete picture of a sophisticated API attack has been conducted and/or evolved step-by-step targeting across multiple attack phases. The collected request and response data 124 associated with API calls may form an API data lake. The API data lake may provide 360-degree contextual data on each of the API calls.

In some embodiments, the API sequencing engine 204 may combine one or more features of the collected request and response data. The one or more features may be associated with a login behavior, an API request content and behavior, an API object accessing content and behavior, and an API response content and behavior. The login behavior (a.k.a. where they come from) may not only be used to identify the attacks from known bad sources but also to correlate the organized attacks across multiple actors. Further, the login behavior may be stored as the login behavior data 212 in the data storage unit 122 or the API data lake. The login behavior data 212, without any limitation, include Internet Protocol (IP) address, geolocation, organization, and Autonomous System Number (ASN) of the origin of the API call. The API request content and behavior (a.k.a. what they do) may be used as a unique fingerprint to identify those special-purposed behavior conducted by attackers. The data associated with API request content and behavior may be stored as the API request content and behavior data 214 and may, without any limitation, include API endpoints and a time-series pattern of API calls during a particular user session. The API object accessing content and behavior (a.k.a. what they target) may be used to identify and correlate the intention and target of a potential attack, like Broken Object Level Authorization (BOLA). The data associated with API object accessing content and behavior may be stored as the API object accessing content and behavior data 216 and may, without any limitation, include all object types and object values that a user accesses during a particular user session. The API response content and behavior (a.k.a. what they get) may be used to identify the intention and potential damage of an attack. The data associated with API response content and behavior may be stored as the API response content and behavior data 218 and may, without any limitation, include a response status code and/or a body content that a user receives during a particular user session.

In an embodiment, the API sequence engine 204 may encode the combined one or more features to create a behavior fingerprint of each of the one or more user sessions. The combined one or more features may be encoded via a neural network based embedding model such as a Recurrent Neural Network (RNN). The behavior analytics system 110 may also employ one or more Artificial Intelligence (AI) models for various purposes, such as an XGBoost for remote command execution, a principal component analysis for API correlation analysis, a support vector machine for SQL injection detection, a logistic regression for threat actor impact scoring, a temporal anomaly detection for endpoint behavior anomaly, and a peer behavior grouping for the BOLA. The behavior analytics system 110 may also employ one or more Machine Learning (ML) models for various purposes, such as a transformer model for API learning and understanding, a large language model for sensitive data classification, and a graph neural network for user behavior correlation.

In some embodiments, the clustering engine 206 may detect a normal or an abnormal user behavior based on the created behavior fingerprint of each of the one or more login sessions. In an embodiment, behavior anomaly detection may be performed in two phases. The first phase may be to validate and implement an individual behavior anomaly model to detect some specific types of attacks, for example, login behavior anomaly for fake account creation detection, object anomaly detection for BOLA and BLFA detection, etc. The second phase may be to correlate different anomaly events following the MITRE attack framework across one or multiple actors to detect the larger scope of organized attacks/incidents.

In some embodiments, the clustering engine 206 may perform the object anomaly detection that focuses on the behavior of how a user is accessing the sensitive object. In order to perform the object anomaly detection, the behavior analytics system 110 may analyze how a user or service is accessing sensitive object types. For detecting anomalies associated with each use case or attach type, the behavior analytics system 110 may build a normal behavior baseline based on the majority of normal users and detect outliers as the potential exploits or attacks.

In order to perform the object anomaly detection, the clustering engine 206 may first identify the sensitive object types that are susceptible to attacks (i.e., numbers, strings, uuids, etc.), and accessible to sensitive information to the user or service initiating the API calls. It may be noted that objects that are typically the targets for attacks may be mainly focused on the object anomaly detection. Such objects for example may include, without limitation, a payment-id, an invoice-id, a payout-id for payment applications, or signup-id, identity-id, term-policy-id, application-id for insurance companies. It may be noted that zip codes, city, time, and name may not be good objects to focus on for the object anomaly detection. Further, in order to perform object anomaly detection, a normal behavior baseline (also termed as a pre-defined threshold) may also be built on a majority of normal users to detect the outlines as potential exploits or attacks. Such normal behavior baseline may be built based on sensitive objects (such as user-id, identity-id, term-policy-id) combined over different APIs. In some embodiments, an organization associated with the protected environment 108 may also add or remove a certain type of object for monitoring by either defining them in the configuration or removing them via the event feedback to personalize the behavior analytics system 110. For maintaining the flow of the disclosure, the object behavior baselining has been discussed in detail in the following paragraphs.

In some embodiments, the report and response engine 208 may report the detected abnormal user behavior. In an embodiment, the report and response engine 208 may send reports of the detected abnormal user behavior to a concerned person, such as a system administrator, a user, a security manager, an IT manager, an owner, or the like to facilitate the concerned person to validate the detected user behavior. Further, the report and response engine may take a necessary action to mitigate the effects of the abnormal user behavior based on the validation of the concerned person. In another embodiment, the report and response engine 208 automatically takes the necessary action to mitigate the effects of the abnormal user behavior if magnitude of associated threat is more than a pre-defined threshold.

In some embodiments, for each sensitive object type, the object behavior baselining may be built by tracking the bidirectional relationship between the user and the object. Such tracking may include object accessing behavior of the user i.e., a user should not access too many objects of a certain type relative to the historical or peer baseline. For example, an account tried to use 20 k {asset-id} in a day, which may be higher than the historical baseline (e.g., ˜1). Further, such tracking also includes object ownership behavior to catch users excessively accessing the shared objects that may not be commonly sharable. For example, {authorization-id} that is not usually shared. It may be understood that if the user-object behavior does not change often for a certain API, a growing window of a minimum of 3 days and up to 2 weeks of telemetry data may be utilized to build the behavior baseline. Such baseline learning may be done with a daily batch job of one or more of: 1) creating the daily snapshot of the user-object bipartite graph, 2) merging the daily snapshot for the past X days, and 3) learning the parameters of the user accessing object behavior and object ownership from the merged snapshot data. Typically, such object behavior baselining may start with preprocessed head span data that may have some important field extracted with one or more records (also terms as a span). Further, parts of the spans that may be determined to be susceptible to potential abuse and tempering may be extracted via, for example, the BOLA pipeline. In such scenarios, the detection logic may be built based on a bipartite graph based on user_id as objects. For example, in each session, a user accesses some susceptible objects of a certain type, while each object the user accesses may be just accessed/owned by one user or more users. Since some objects may be more prone to share than others, it depends on the object's “type”—for example, an object associated with a billing agreement id may be very unlikely to be shared among many unrelated users, however, product-IDs may be easily shared by a lot of users who do not have previously established relationships. Accordingly, with continuous learning of the normal user-object behavior for each sensitive object type from telemetry data, the parameters may be updated and fed into the runtime anomaly engine for detection.

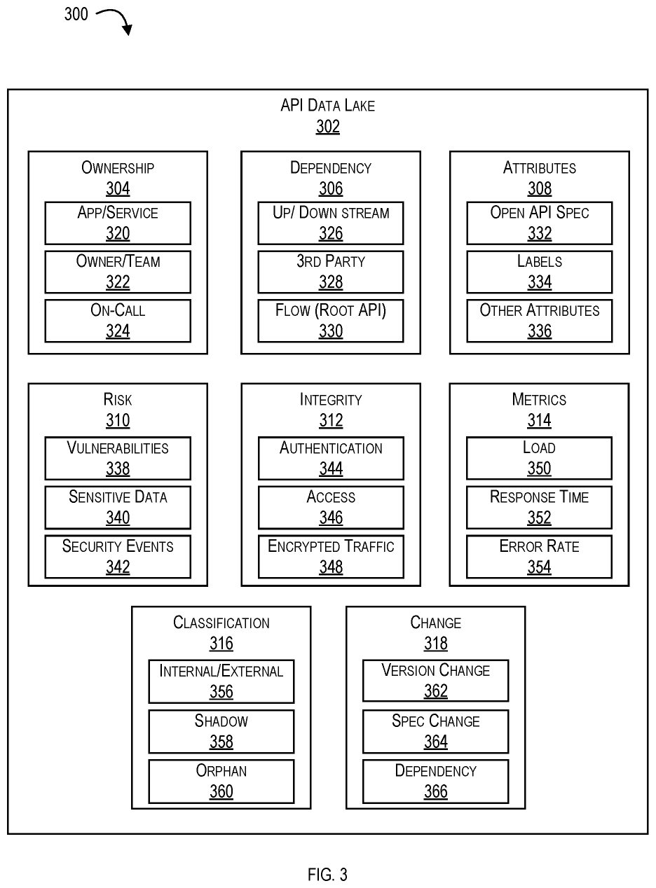

FIG. 3 shows exemplary data 300 that is stored in an API data lake 302, in accordance with an embodiment of the present disclosure. The API data lake 302 maintains a 360-degree context of each APIs and request and response data of each API calls. It may be noted that the full context of the general behavior may require capturing and learning from every API call. In an embodiment, the API calls for the API may be associated with commands such as external, internal, mirror, edge in-app, serverless, and 3^{rd} party and partner. In an illustrated embodiment, the data lake may be the API data lake 302 that may store data associated with ownership 304, dependency 306, attributes 308, risk 310, integrity 312, metrics 314, classification 316, and change 318 associated with each of APIs. The API data associated with ownerships 304 may, without any limitation, be related to app/service ownership 320, user/team ownership 322, and on-call ownership 324. The API data associated with dependency 306 may, without any limitation, be related to up/downstream dependency 326, 3^{rd} party dependency 328, and flow i.e., root API dependency 330. The API data associated with attributes 308 may, without any limitation, be related to open API specification 332, labels 334, and other attributes 336. The API calls associated with risk 310 may, without any limitation, be related to vulnerability type 338, sensitive data type 340, and security event types 342. The API data associated with integrity 312 may, without any limitation, be related to authentication integrity 344, access integrity 346, and encrypted traffic integrity 348. The API data associated with metrics 314 may, without any limitation, be related to load 350, response time 352, and error data 354. The API data associated with classification 316 may, without any limitation, be related to internal/external 356, shadow 358, and orphan 360. The API data associated with change 318 may, without any limitation, be related to version change 362, specification change 364, and dependency changes 366.

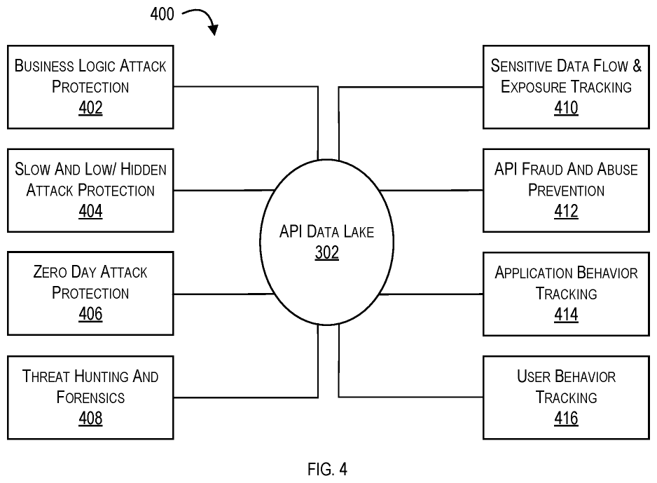

FIG. 4 shows exemplary uses 400 of the API data lake 302 that provides 360-degree contextual data of each API, in accordance with an embodiment of the present disclosure. In an embodiment, as illustrated in FIG. 4, the API data lake of the behavior analytics system 110 may be used to provide 360-degree protection including, but not limited to, a business logic attack protection 402, a slow and low-hidden attack protection 404, a zero data attack protection 406, threat hunting and forensics 408, a sensitive data flow and exposure tracking 410, and an API fraud and abuse prevention 412. The API data lake 302 may be used for an application behavior tracking 414, and a user behavior tracking 416.

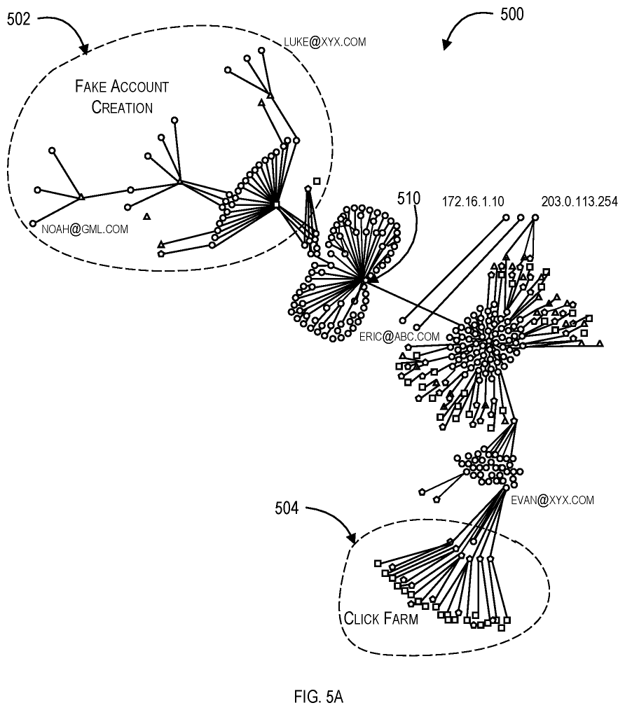

FIG. 5A shows exemplary clusters 500 created by the clustering engine 206 to detect normal and abnormal user behavior indicating fake accounts that can be detected by the behavior analytics system 110, in accordance with an embodiment of the present disclosure. FIG. 5B shows an exemplary cluster indicating fake accounts using the behavior analytics system 110, in accordance with an embodiment of the present disclosure. For the brevity of the explanation, FIGS. 5A and 5B have been explained together. FIG. 5A and FIG. 5B illustrate a use case of fake account creation detected using the behavior analytics system 110. For specific use cases of detecting the fake account creation, features such as unique user accounts, and IP addresses can be used to create login behavior fingerprints of different user sessions. The Clustering engine 206 can then create clusters 500 from fingerprints as shown in FIG. 5A. Based on the clustered data, a set of fake user accounts (e.g., 508A, 508B, 508C, 508N), bot IPs 506, proxy IPs 510, and benign IPs 506 can be determined. The behavior analytics system 110 may mark the cluster 502 to indicate fake accounts are created using these accounts 508 and IPs. The cluster 504 has several bot IPs having similar fingerprints. The behavior analytics system 110 may mark the cluster 504 to indicate a click farm attack, where a large group of low-paid workers may have been hired to click on paid advertising links for the click fraudster or initiated a denial of service (DOS) attack. In such scenarios, the behavior analytics system 110 may utilize NLP Entropy Detection, Bipartite Graph Clustering models, belief propagation model, and other Machine Learning (ML) models to monitor one or more features to detect an anomaly such as fake account creation fraud detection. The one or more features may, without any limitation, include login behavior, time interval of consecutive logins (to detect if it is a bot or script behavior), and/or the reputation of the source IPs. Such one or more features may be monitored based on the associated IP addresses, the first detection of account creation from such IP, and the last detection of account creation from such IP. As shown in FIG. 5B, a first IP 506 may be utilized to create multiple accounts 508A, then some of those accounts may be associated with a second IP, which is used as proxy IP 506 to create more fake accounts. Further, several accounts 508B may then be created from the second IP 506. Similarly, one of such several accounts 508B may be accessed from a third IP 506 and further, some accounts 508C may be created from the third IP 506. The behavior analytics system 110 may monitor and detect such patterns to identify fraud, severity score, and confidence level to mitigate the effects of such frauds by, for example, blocking the associated IPs or blocking the associated accounts.

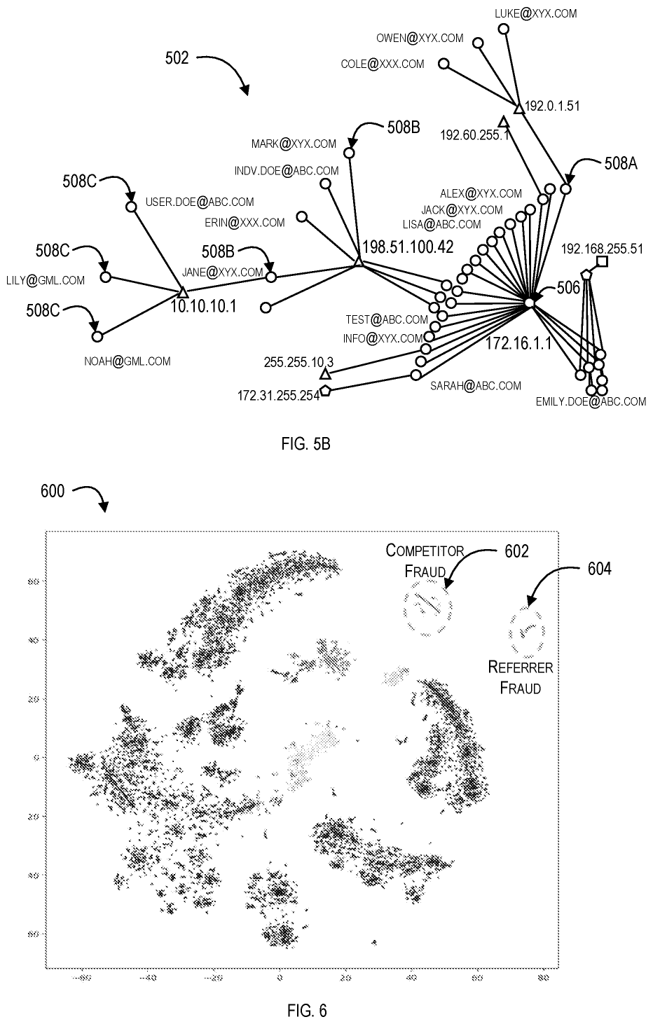

FIG. 6 shows another exemplary outlier in the clusters 600 indicating potential fraud that can be detected by the behavior analytics system 110, in accordance with an embodiment of the present disclosure. In an illustrated embodiment, the behavior analytics system 110 may be implemented in the protected environment 108 such as life insurance companies for detection and mitigating the effects of business logic abuse. In such a scenario, the behavior analytics system 110 may monitor behavior such as API request content and behavior and API object access content and behavior. The behavior analytics system 110 may utilize a sequence embedding model and a peer behavior clustering model to monitor such behaviors and detect competitor fraud and referrer fraud based on the clustering of fingerprints in cluster 602 and cluster 604 respectively. Upon detecting the competitor fraud and the referrer fraud, the behavior analytics system 110 may report such fraud to a concerned person for validation. Further, the behavior analytics system 110 may apply a necessary solution, such as blocking the account or applying restrictions to the account based on the received validation. In another embodiment, the behavior analytics system 110 may also calculate a severity score and if the calculated severity score is more than a threshold value then the behavior analytics system 110 may bypass the process of receiving validation and may automatically apply the necessary solution to mitigate the effects of the detected fraud.

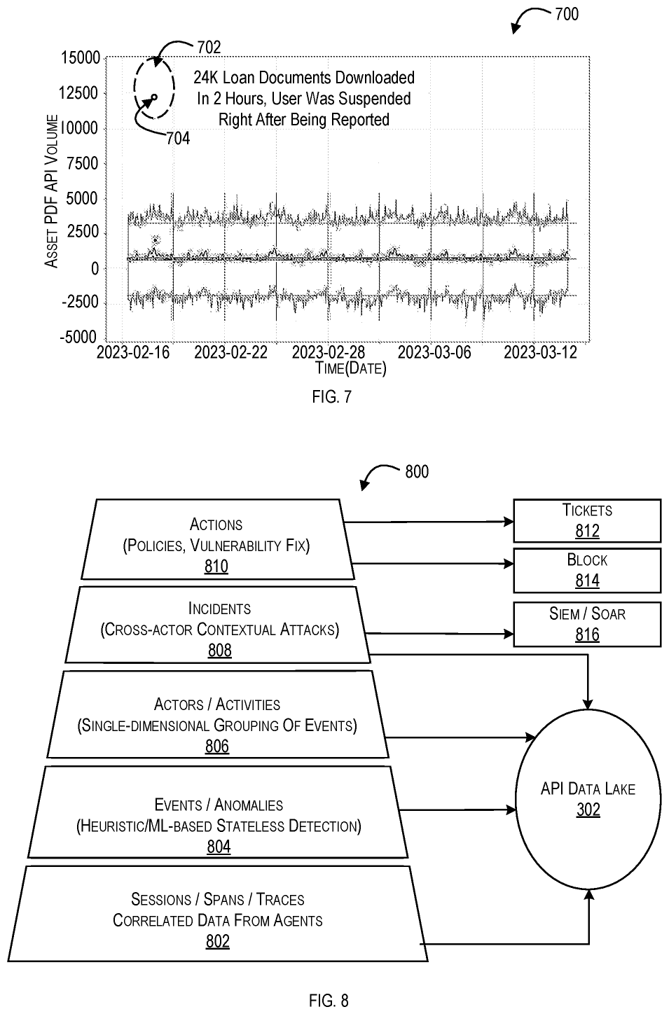

FIG. 7 shows yet another exemplary cluster indicating a data exfiltration attack that can be detected by the behavior analytics system 110, in accordance with an embodiment of the present disclosure. In an illustrated embodiment, the behavior analytics system 110 may be implemented in the protected environment 108 such as a loan company for detecting and mitigating the effects of BOLA, Authorization To Operate (ATO), and data exfiltration attacks. Since for such anomalies, a client device 104 or a service copy/download one or more files (such as via access a database or via the API without hacking into the internal database), such anomalies may be detected by monitoring object accessing behavior and response content behavior of API calls to the protected environment 108. The behavior analytics system 110 may utilize a principal component analysis model and/or a time-series anomaly detection model to detect such anomalies. Such anomalies may be detected by baselining the normal accessing behavior for accessing critical and/or sensitive resources for each user/each user group to detect a noticeable deviation. The noticeable deviation may correspond to a deviation that is more than a pre-defined threshold values and may be referred to as the detected anomaly. In an illustrated embodiment, the behavior analytics system 110 may detect that a particular client device 104 downloaded 24K loan documents in 2 hours, as shown by samples 702 and 704. Upon detecting the downloading of more than 24K loan documents in 2 hours, the behavior analytics system 110 may compare the number of documents with a threshold value that may be less than 2.5 k. Based on the comparison, the behavior analytics system 110 automatically takes a necessary response, such as suspending the user account associated with the client device 104 to mitigate the effects of exfiltration associated with downloading of such number of documents.

In an implementation, the behavior analytics system 110 may be utilized to detect and mitigate the effects of signature-based attacks by monitoring authentication/authorization such as via JWT/bearer, Oauth, and OIDC. Additionally, the behavior analytics system 110 may monitor language-specific exploits such as zero data high priority CVE/CWEs and security misconfigurations such as API gateways and load balancers. After the detection of the signature-based attacks, the behavior analytics system 110 may mitigate the effects of signature-based attacks by virtual patching.

In another implementation, the behavior analytics system 110 may be utilized to detect behavior-based attacks by monitoring advanced rate limiting, enumeration-based attacks, malicious bots/TOR/proxy, account takeover, credential stuffing, and API abuse (such as referral/gift card, fraud, fake account creation, and payment fraud). After the detection of the behavior-based attacks, the behavior analytics system 110 may mitigate the effects of behavior-based attacks by applying Distributed Denial-of-Service (DDoS).

In yet another implementation, the behavior analytics system 110 may be utilized to provide data protection by detecting sensitive data leaks (such as data breaches, unintended partners, and internal attacks) and volumetric data exfiltration. Further, upon detecting the breach of data protection, the behavior analytics system 110 may stop further data breaches by geo-fencing the sensitive data, accessing data policies, and providing compliance via GDPR, CCPA, and/or PII/PCI.

FIG. 8 shows a block diagram 800 illustrating comprehensive data collection, threat detection, and reporting offered for API protection by the behavior analytics system 110, in accordance with an embodiment of the present disclosure. The behavior analytics system 110 provides manageable, explainable, and actionable reports or live dashboards. As the number of high-confidence incidents are limited, the report or dashboard will be easy to manage the incidents. As the baseline for each anomaly is dynamically determined by the ML model that also takes earlier incidents confirmed or rejected by the system administrator, the chances of false positives will be very less. The behavior analytics system 110 may offer a hierarchical investigation workflow that makes the incident easily explainable. The behavior analytics system 110 may also provide integrated and automated remediation actions for each type of API-based attack. In an embodiment, the behavior analytics system 110 may correlate data from agents (users or services) from multiple sessions, spans, or traces, as shown at block 802. Based on the correlated data, the behavior analytics system 110 may perform heuristic/ML-based stateless detection of events or anomalies for specific use cases or attack types, as shown at block 804. Further, the behavior analytics system 110 may perform a single-dimensional grouping of events/anomalies to determine actors and activities, as shown at block 806. The behavior analytics system 110 then performs cross-actor contextual attack detection to detect incidents, as shown at block 808. Based on the detected incidents policies and vulnerability fix actions can be taken, as shown at block 810. Collected data, detected events or anomalies, detected actors or activities, detected incidents, and actions taken can be stored in the API data lake 302. In an embodiment, for taking actions, appropriate tickets 812, on Jira, ServiceNow, Slack or any other tool designed for that purpose can be generated and assigned to a concerned person. In an embodiment, the behavior analytics system 110 automatically takes action to block certain users or services involved in the API-based attack. In an embodiment, the behavior analytics system 110 may submit detected incidents to security data aggregator tools, such as Security Information and Event Management (SIEM) tool, or Security Orchestration Automaton, and Response (SOAR) tool, as shown at block 816.

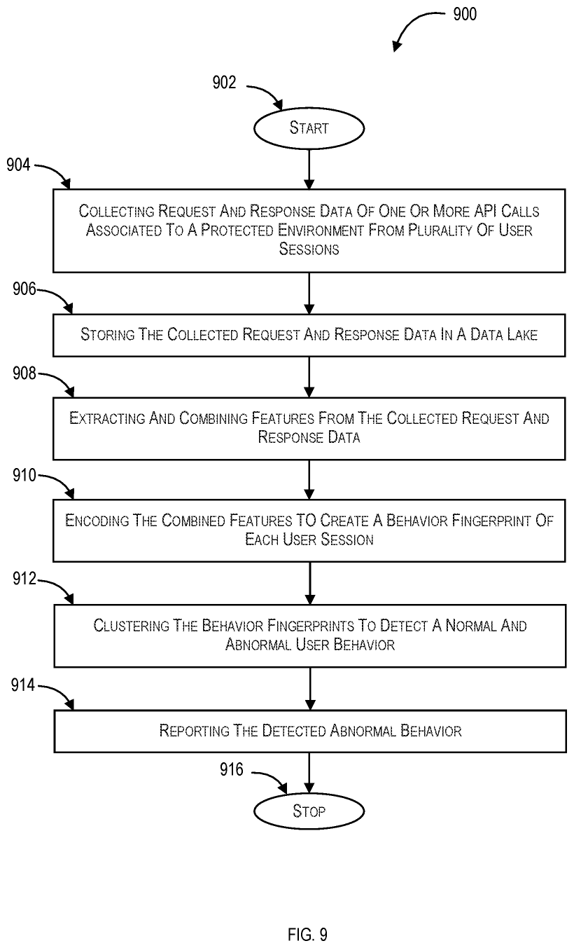

FIG. 9 is a flow chart of a method 900 for detecting and preventing different types of API based threats and attacks based on behavior analytics, in accordance with an embodiment of the present disclosure. The method starts at step 902.

At first, requests and responses data of one or more API calls associated to an application in a protected environment from a plurality of user sessions may be collected, at step 904. It may be noted that for the sake of the present disclosure, the one or more user sessions correspond to a period of time in which the user accesses the protected environment, i.e., period during which users initiate API calls and receive response to API calls, including API calls made during authentication, authorization and any subsequent request and response to and from any of the resources or services. Next, at step 906, the behavior analytics method may store the collected response and requests data in a data lake for detailed analysis at any point of time.

Next, at step 908, one or more features extracted from the collected requests and responses data may be extracted and combined. The one or more features may be associated with a login behavior, an API request content and behavior, an API object accessing content and behavior, and an API response content and behavior. The login behavior (a.k.a. where they come from) may not only be used to identify the attacks from known bad sources but also to correlate the organized attacks across multiple actors. Further, the login behavior may be stored as the login behavior data in the data storage unit or the API data lake. The login behavior data, without any limitation, include Internet Protocol (IP) address, geolocation, organization, and Autonomous System Number (ASN) of the origin of the API call. The API request content and behavior (a.k.a. what they do) may be used as a unique fingerprint to identify those special-purposed behavior conducted by attackers. The data associated with API request content and behavior may be stored as the API request content and behavior data and may, without any limitation, include API endpoints and a time-series pattern of API calls during a particular user session. The API object accessing content and behavior (a.k.a. what they target) may be used to identify and correlate the intention and target of a potential attack, like Broken Object Level Authorization (BOLA). The data associated with API object accessing content and behavior may be stored as the API object accessing content and behavior data and may, without any limitation, include all object types and object values that a user accesses during a particular user session. The API response content and behavior (a.k.a. what they get) may be used to identify the intention and potential damage of an attack. The data associated with API response content and behavior may be stored as the API response content and behavior data and may, without any limitation, include a response status code and/or a body content that a user receives during a particular user session.

Next, at step 910, the combined one or more features may be encoded via a neural network based embedding model to create a behavior fingerprint of each of the one or more user sessions. The combined one or more features may be encoded via a neural network based embedding model such as a Recurrent Neural Network (RNN). Alternatively, or additionally, the behavior analytics method may also employ one or more Artificial Intelligence (AI) models for various purposes, such as an XGBoost for remote command execution, a principal component analysis for API correlation analysis, a support vector machine for SQL injection detection, a logistic regression for threat actor impact scoring, a temporal anomaly detection for endpoint behavior anomaly, and a peer behavior grouping for the BOLA. The behavior analytics method may also employ one or more Machine Learning (ML) models for various purposes, such as a transformer model for API learning and understanding, a large language model for sensitive data classification, and a graph neural network for user behavior correlation.

Next, at step 912, the created behavior fingerprints of the one or more user sessions may be clustered to detect a normal or an abnormal user behavior. Upon detection of the abnormal behavior, the detected abnormal user behavior may be reported, at step 914. In one embodiment, the behavior analytics method may send reports of the detected abnormal user behavior to a concerned person, such as a system administrator, a user, a security manager, an IT manager, an owner, or the like to facilitate the concerned person to validate the detected user behavior. Additionally, or alternatively, the behavior analytics method may take a necessary action to mitigate the effects of the abnormal user behavior based on the validation of the concerned person. The method ends at step 916.

Thus, the disclosure provides a framework for analyzing and monitoring API behavior to identify and mitigate potential security threats to ensure the confidentiality, integrity, and availability of their APIs and the data they handle. Since such a framework is a common framework for monitoring and analyzing security risks at different phases of the attack chain, the framework can be deployed to mitigate security threats during the complete attack chain. As a result, the framework provides extensibility and/or efficiency of data infrastructure and pipelines during data processing, extraction, transformation, and loading across different attacks.

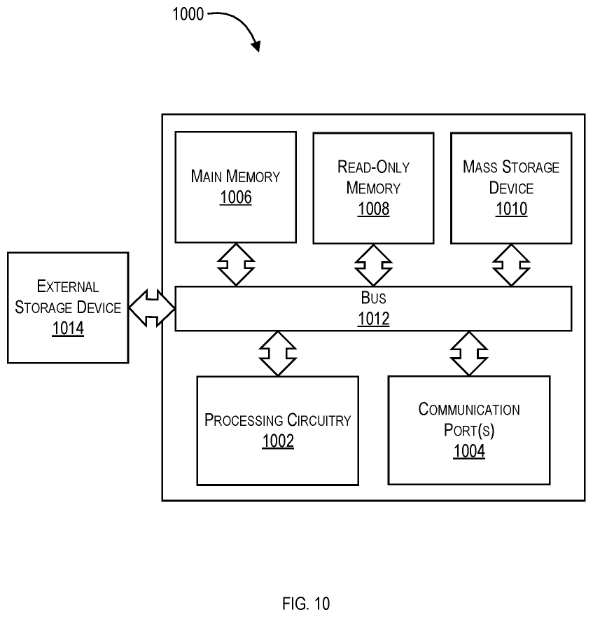

FIG. 10 illustrates an exemplary computer system in which or with which embodiments of the present disclosure may be utilized. As shown in FIG. 10, a computer system 1000 includes an external storage device 1014, a bus 1012, a main memory 1006, a read-only memory 1008, a mass storage device 1010, a communication port 1004, and a processor 1002.

Those skilled in the art will appreciate that computer system 1000 may include more than one processor 1002 and communication ports 1004. Examples of processor 1002 include, but are not limited to, an Intel® Itanium® or Itanium 2 processor(s), or AMD® Opteron® or Athlon MP® processor(s), Motorola® lines of processors, FortiSOC™ system on chip processors or other future processors. The processor 1002 may include various modules associated with embodiments of the present disclosure.

The communication port 1004 can be any of an RS-232 port for use with a modem-based dialup connection, a 10/100 Ethernet port, a Gigabit or 10 Gigabit port using copper or fiber, a serial port, a parallel port, or other existing or future ports. The communication port 1004 may be chosen depending on a network, such as a Local Area Network (LAN), Wide Area Network (WAN), or any network to which the computer system connects.

The memory 1006 can be Random Access Memory (RAM), or any other dynamic storage device commonly known in the art. Read-Only Memory 808 can be any static storage device(s) e.g., but not limited to, a Programmable Read-Only Memory (PROM) chips for storing static information e.g., start-up or BIOS instructions for processor 1002.

The mass storage 1010 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), e.g. those available from Seagate (e.g., the Seagate Barracuda 7200 family) or Hitachi (e.g., the Hitachi Deskstar 7K1000), one or more optical discs, Redundant Array of Independent Disks (RAID) storage, e.g. an array of disks (e.g., SATA arrays), available from various vendors including Dot Hill Systems Corp., LaCie, Nexsan Technologies, Inc. and Enhance Technology, Inc.

The bus 1012 communicatively couples processor(s) 1002 with the other memory, storage, and communication blocks. The bus 1012 can be, e.g., a Peripheral Component Interconnect (PCI)/PCI Extended (PCI-X) bus, Small Computer System Interface (SCSI), USB, or the like, for connecting expansion cards, drives, and other subsystems as well as other buses, such a front side bus (FSB), which connects processor 1002 to a software system.

Optionally, operator and administrative interfaces, e.g., a display, keyboard, and a cursor control device, may also be coupled to bus 1004 to support direct operator interaction with the computer system. Other operator and administrative interfaces can be provided through network connections connected through communication port 1004. An external storage device 1010 can be any kind of external hard-drives, floppy drives, IOMEGA® Zip Drives, Compact Disc-Read-Only Memory (CD-ROM), Compact Disc-Re-Writable (CD-RW), Digital Video Disk-Read Only Memory (DVD-ROM). The components described above are meant only to exemplify various possibilities. In no way should the aforementioned exemplary computer system limit the scope of the present disclosure.

While embodiments of the present disclosure have been illustrated and described, it will be clear that the disclosure is not limited to these embodiments only. Numerous modifications, changes, variations, substitutions, and equivalents will be apparent to those skilled in the art, without departing from the spirit and scope of the disclosure, as described in the claims.

Thus, it will be appreciated by those of ordinary skill in the art that the diagrams, schematics, illustrations, and the like represent conceptual views or processes illustrating systems and methods embodying this disclosure. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this disclosure. Those of ordinary skill in the art further understand that the exemplary hardware, software, processes, methods, and/or operating systems described herein are for illustrative purposes and, thus, are not intended to be limited to any particular named.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of this document terms “coupled to” and “coupled with” are also used euphemistically to mean “communicatively coupled with” over a network, where two or more devices can exchange data with each other over the network, possibly via one or more intermediary device.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

While the foregoing describes various embodiments of the disclosure, other and further embodiments of the disclosure may be devised without departing from the basic scope thereof. The scope of the invention is determined by the claims that follows. The invention is not limited to the described embodiments, versions, or examples, which are included to enable a person having ordinary skill in the art to make and use the disclosure when combined with information and knowledge available to the person having ordinary skill in the art.

What is claimed is:

1. A behavior analytics system for different types of Application Programming Interface (API) vulnerabilities and attacks, the behavior analytics system comprises:
a collection engine to collect requests and responses of one or more API calls associated to an application in a protected environment made during one or more login sessions;
an API sequence engine to:
combine one or more features extracted from the collected requests and responses, wherein the one or more features are associated with login behavior, API request content and behavior, API object accessing content and behavior, and API response content and behavior; and
encode the combined one or more features via a neural network based embedding model to create a behavior fingerprint of each of the one or more login sessions;
a clustering engine to detect at least one of: a normal and an abnormal user behavior based on the created behavior fingerprint of each of the one or more login sessions; and
a report and response engine to report the detected abnormal user behavior.

2. The behavior analytics system as claimed in claim 1, wherein the user is facilitated to validate the provided user behavior.

3. The behavior analytics system as claimed in claim 2, wherein the report and response engine take a necessary action to mitigate the effects of the abnormal user behavior based on the validation of the user.

4. The behavior analytics system as claimed in claim 1, wherein the report and response engine automatically take a necessary action to mitigate the effects of the abnormal user behavior if magnitude of associated threat is more than a pre-defined threshold.

5. The behavior analytics system as claimed in claim 1, wherein the collection engine stores the collected requests and responses in a data lake for detailed analysis at any point of time.

6. The behavior analytics system as claimed in claim 1, wherein the requests and responses correspond to one or more API calls made by at least one of: one or more users and services.

7. The behavior analytics system as claimed in claim 6, wherein the one or more API calls includes at least one of: initial authentication, authorization, and one or more Hyper Text Transfer Protocol (HTTP) requests and responses in the login session.

8. The behavior analytics system as claimed in claim 1, wherein the login behavior includes at least one of: Internet Protocol (IP) address, geolocation, organization, and Autonomous System Number (ASN) of the origin where a user comes from.

9. The behavior analytics system as claimed in claim 1, wherein the API request content and behavior includes at least one of: API endpoints and a time-series pattern a user accesses different APIs during a particular login session.

10. The behavior analytics system as claimed in claim 1, wherein the API object accessing content and behavior includes all object types and object values that a user accesses during a particular login session.

11. The behavior analytics system as claimed in claim 1, wherein the API response content and behavior includes at least one of: a response status code and a body content that a user receives during a particular login session.

12. A behavior analytics method for different types of Application Programming Interface (API) vulnerabilities and attacks, the behavior analytics method comprises:
collecting requests and responses of one or more API calls associated to an application in a protected environment made during one or more login sessions;
combining one or more features extracted from the collected requests and responses, wherein the one or more features are associated with login behavior, API request content and behavior, API object accessing content and behavior, and API response content and behavior;
encoding the combined one or more features via a neural network based embedding model to create a behavior fingerprint of each of the one or more login sessions;
detecting at least one of: a normal and an abnormal user behavior based on the created behavior fingerprint of each of the one or more login sessions; and
reporting the detected abnormal user behavior.

13. The behavior analytics method as claimed in claim 12, further comprises:
facilitating a user to validate the provided user behavior; and
taking a necessary action to mitigate the effects of the abnormal user behavior based on the validation of the user.

14. The behavior analytics method as claimed in claim 12, further comprises taking a necessary action to mitigate the effects of the abnormal user behavior if magnitude of associated threat is more than a pre-defined threshold.

15. The behavior analytics method as claimed in claim 12, further comprises storing the collected requests and responses in a data lake for detailed analysis at any point of time.

16. The behavior analytics method as claimed in claim 12,
wherein the requests and responses correspond to one or more API calls made by at least one of: one or more users and services, and
wherein the one or more API calls include at least one of: initial authentication, authorization, and one or more Hyper Text Transfer Protocol (HTTP) requests and responses in the login session.

17. The behavior analytics method as claimed in claim 12, wherein the login behavior includes at least one of: Internet Protocol (IP) address, geolocation, organization, and Autonomous System Number (ASN) of the origin where a user comes from.

18. The behavior analytics method as claimed in claim 12, wherein the API request content and behavior includes at least one of: API endpoints and a time-series pattern a user accesses different API during a particular login session.

19. The behavior analytics method as claimed in claim 12, wherein the API object accessing content and behavior includes all object types and object values that a user accesses during a particular login session.

20. The behavior analytics method as claimed in claim 12, wherein the API response content and behavior includes at least one of: a response status code and a body content that a user receives during a particular login session.
